(19) United States
(12) Patent Application Publication
(10) Pub. No.: US 2009/0321607 A1
(43) Pub. Date: Dec. 31, 2009

(54) Three point mounting arrangement for a power system

(75) Inventors: Peter John Baron, San Diego, CA (US); Martin Regis Habel, San Diego, CA (US)

Correspondence Address: CATERPILLAR/FINNEGAN, HENDERSON, L.L.P., 901 New York Avenue, NW, WASHINGTON, DC, 20001-4413, US

(73) Assignee: Solar Turbines Inc.

(21) Appl. No.: 12/216,120

(22) Filed: Jun. 30, 2008

(51) Int. Cl. F16F 15/023; F16M 13/00

(52) U.S. Cl. 248/562; 248/560; 267/137

(57) ABSTRACT

A mounting system for supporting a power system is disclosed. The mounting system may have a support structure including a first end spaced from a second end of the support structure. The mounting system may further have a first mounting assembly attached near the first end of the support structure. The first mounting assembly may have a first mounting support and a second mounting support for supporting the support structure, each of the first mounting support and the second mounting support attached to the support structure offset to a side of a longitudinal axis. The mounting system may also have a second mounting assembly attached near the second end of the support structure. The second mounting assembly may have a third mounting support attached to the support structure below the longitudinal axis for supporting the support structure. The second mounting assembly may have at least one shock absorber mounted near the third mounting support.

### TECHNICAL FIELD

The present disclosure relates generally to a mounting arrangement for a power system and, more particularly, to a three point mounting arrangement including a shock absorber.

### BACKGROUND

Many power systems include a drive mechanism powering a driven mechanism. Known drive mechanisms include, for example, electric motors, diesel engines, and gas turbine engines. Known driven mechanisms include, for example, pumps, compressors, and generators. Where a power system is a rotary power system, the drive mechanism may be coupled to the driven mechanism via one or more rotary drive members, such as a rotary drive axle. In order to help maintain proper alignment of the rotary drive axle between the drive mechanism and the driven mechanism, it is common to support the drive mechanism and the driven mechanism on a common support structure.

The support structure is mounted on an underlying base surface, such as, the deck of an off-shore platform, the floor of a building, or the ground. Some mounting systems support the support structure on the base surface in a manner that permits relative movement between the support structure and the base surface. For example, anti-vibration mounts and gimbals may be mounted between the support structure and the base surface to permit some movement of the support structure relative to the base surface. Anti-vibration mounts and gimbals may serve to absorb vibrations or otherwise permit relative movement of the support structure to protect and assist operation of the power system mounted on the support structure. For example, known anti-vibration mounts may use a resilient material to absorb vibrations including, for example, rubber. Additionally, three point mounting arrangements including, for example, an arrangement mounting the support structure on two side-by-side supports and a third support spaced from the first two, are known to permit twisting of the support structure about the third support. However, known three point mounting arrangements may, in at least some circumstances and/or applications, fail to adequately regulate the amount of twisting permitted in the support structure to protect the power system from damage under abnormally high torque, such as reactionary torque generated by an electric motor when it short circuits. While permitting at least some twisting of the support structure to absorb normal operating torque generated by the power system may help protect the power system from damage, permitting excessive twisting of the support structure caused by abnormally high operating torque levels may cause extensive damage to the power system.

A mounting arrangement guiding movement of a power system is disclosed in U.S. Pat. No. 2,981,463 issued to Dagrell ('463 patent). The '463 patent discloses a power motor driving a propeller fan for moving hot gases. The '463 patent discloses mounting the power motor on a concrete foundation at a height axially aligned with the propeller fan. The '463 patent also discloses that a fan housing enclosing the propeller fan is mounted on a pair of side-by-side bearing plates via spring-biased bolts to permit thermal expansion of the fan housing. Movement of the fan housing is further guided by a pair of guide mechanisms positioned between each pair of side-by-side bearing plates.

The system of the '463 patent may allow for thermal expansion of the fan housing, but fails to permit twisting of its support structure to absorb low-level torque fluctuations generated by the power motor because the guide mechanism substantially limits rotation of the fan housing. Further, the system of the '463 patent rigidly mounts the power motor to the concrete foundation, thereby constraining twisting motion of the power motor.

The disclosed mounting arrangement is directed to overcoming one or more of the shortcomings set forth above and/or other shortcomings in the art.

### SUMMARY

In one aspect, the present disclosure is directed to a mounting system for supporting a power system including a drive mechanism powering a driven mechanism along a longitudinal axis. The mounting system may include a support structure including a first end spaced from a second end of the support structure. The mounting system may further include a first mounting assembly attached near the first end of the support structure. The first mounting assembly may include a first mounting support and a second mounting support for supporting the support structure, each of the first mounting support and the second mounting support being attached to the support structure offset to a side of the longitudinal axis. The mounting system may also include a second mounting assembly attached near the second end of the support structure. The second mounting assembly may include a third mounting support attached to the support structure below the longitudinal axis for supporting the support structure. The second mounting assembly may additionally include at least one shock absorber mounted near the third mounting support, the at least one shock absorber being attached to the support structure offset to a side of the longitudinal axis.

In another aspect, the present disclosure is directed to a method of mounting a drive mechanism and a driven mechanism on a support structure. The method including the step of supporting the driven mechanism near a first end of the support structure and supporting the drive mechanism near a second end of the support structure. The method further including the step of permitting the support structure to twist more proximate the drive mechanism than the driven mechanism in response to torque generated on the support structure below the threshold value. The method also including the step of limiting twisting of the support structure near the drive mechanism when the torque generated on the support structure is above a threshold value.

### BRIEF DESCRIPTION OF THE DRAWINGS

FIG. 1 is a schematic side view of an exemplary mounting arrangement for a power system in accordance with the present disclosure;

FIG. 2 is a schematic end view of a first end of the exemplary mounting arrangement of FIG. 1; and

FIG. 3 is a schematic end view of a second end of the exemplary mounting arrangement of FIG. 1.

### DETAILED DESCRIPTION

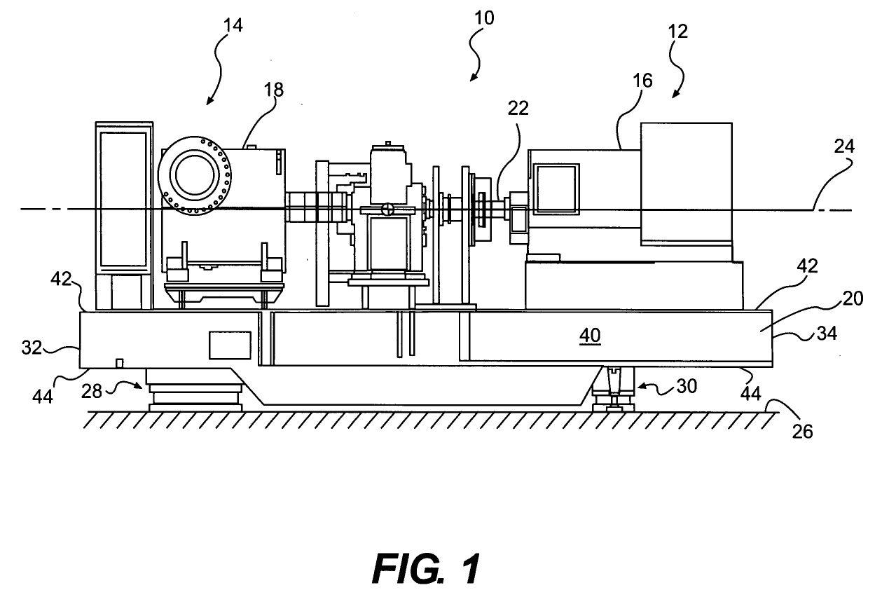

FIG. 1 illustrates an exemplary power system 10, which may include, for example, a drive mechanism 12, a driven mechanism 14, and components for transferring power from drive mechanism 12 to driven mechanism 14. More specifically, drive mechanism 12 may be a rotary drive mechanism and driven mechanism 14 may be a rotary driven mechanism. Drive mechanism 12 may include, for example, an electric motor 16, a diesel engine (not shown), a gas turbine engine (not shown), or any other type of drive mechanism. Driven mechanism 14 may include, for example, a compressor 18, a pump (not shown), a generator (not shown), or any other type of driven mechanism 14. For purposes of explanation, this disclosure describes and shows an electric motor compressor package including electric motor 16 and compressor 18 mounted on a support structure 20. Electric motor 16 may transfer rotational energy to drive compressor 18 via a drive shaft 22 extending along a longitudinal axis 24. Compressor 18 may utilize the rotational energy received from electric motor 16, for example, to increase the pressure or reduce the volume of a gas.

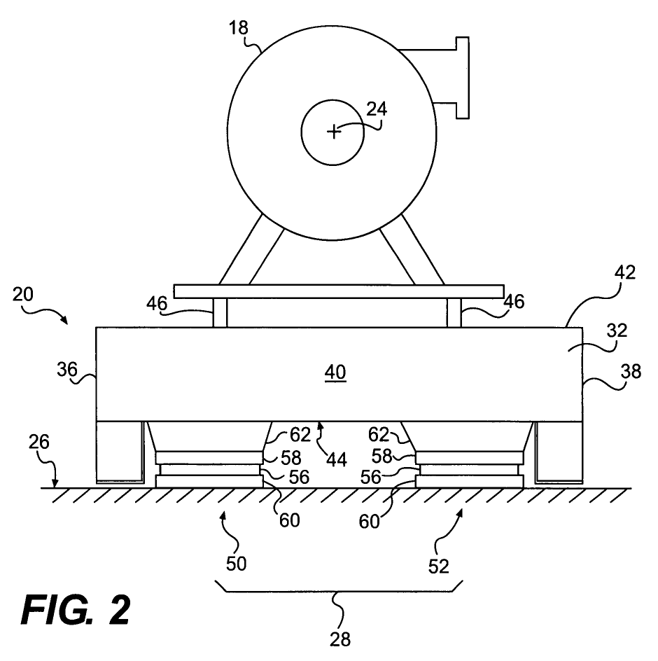

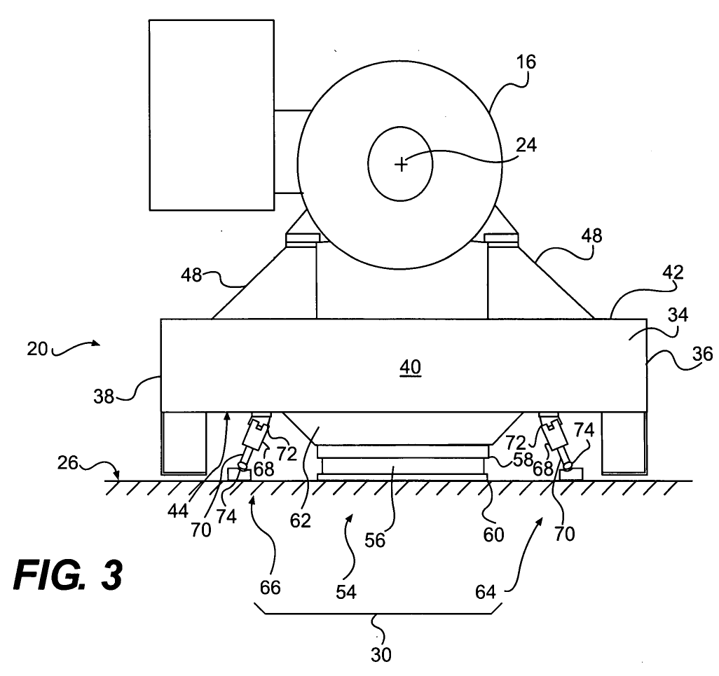

Support structure 20 may be mounted above a base surface 26 via a first mounting assembly 28 and a second mounting assembly 30. More specifically, first mounting assembly 28 may be a compressor mounting assembly and second mounting assembly may be an electric motor mounting assembly. It is contemplated that base surface 26 may be a deck of an off-shore platform, a floor of a building, or any other suitable surface for supporting power system 10. Support structure 20 may include a first end 32 longitudinally spaced from a second end 34. As shown in FIGS. 2 and 3, support structure 20 may also include a first side 36 opposite a second side 38, each spaced to a side of longitudinal axis 24. Support structure 20 may include exterior structural elements 40 at first end 32, second end 34, first side 36, and second side 38 to provide some structural rigidity to support structure 20. Support structure 20 may also include internal structural elements (not shown) disposed inwardly of exterior structural elements 40. Power system 10 may be mounted on an upper surface 42 of support structure 20. First mounting assembly 28 and second mounting assembly 30 may be mounted to a lower surface 44 of support structure 20.

Compressor 18 may be mounted on upper surface 42 of support structure 20 near first end 32, for example, on one or more compressor supports 46 (see FIG. 2). Electric motor 16 may be mounted on upper surface 42 of support structure 20 near second end 34, for example, on one or more motor supports 48 (see FIG. 3). Compressor supports 46 and motor supports 48 may be rigid or may be resilient. First mounting assembly 28 may be connected to support structure 20 beneath compressor 18 and second mounting assembly 30 may be connected to support structure 20 beneath electric motor 16.

As shown in FIG. 2, first mounting assembly 28 may include a first mounting support 50 and a second mounting support 52. First mounting support 50 may be positioned near first side 36 and second mounting support 52 may be positioned near second side 38. For example, first mounting support 50 and second mounting support 52 may be positioned side-by-side and each offset from longitudinal axis 24 to limit twisting of support structure 20 about an axis parallel to longitudinal axis 24 proximate compressor 18. By so limiting twisting of support structure 20 near compressor 18, first and second supports 50, 52 may protect relatively fragile pipe connections and help maintain power train alignment associated with compressor 18.

As shown in FIG. 3, second mounting assembly 30 may include a third mounting support 54 positioned generally beneath electric motor 16 and generally below longitudinal axis 24. Since third mounting support 54 may be centrally mounted beneath support structure 20, third mounting support 54 may permit support structure 20 to twist. Hence, first, second, and third mounting supports 50, 52, 54 may define a three point mounting arrangement that permits limited twisting of support structure 20 about third mounting support 54 proximate electric motor 16. In contrast to compressor 18, electric motor 16 may better resist damage caused by proximate twisting of support structure 20. Electric motor 16 may be positioned on support structure 20 proximate third mounting support 54, and compressor 18 may be positioned on support structure 20 proximate first and second mounting supports 50, 52. Therefore, the second mounting assembly 30 may permit support structure 20 to twist more proximate electric motor 16 than compressor 18 in response to torque generated on support structure 20 that is below a threshold value.

First, second, and third mounting supports 50, 52, 54 may each include an anti-vibration mount, a gimbal, or any known mounting support permitting relative movement between support structure 20 and base surface 26. For purposes of explanation, first, second, and third mounting supports 50, 52, 54 are each described and shown as anti-vibration mounts including a resilient layer 56 sandwiched between an upper plate 58 and a lower plate 60 and held together with one or more fasteners (not shown), adhesive material, and/or any other known method of binding layers of materials. Resilient layer 56 may be manufactured from any known material capable of absorbing vibrations. It is contemplated that resilient layer 56 may be formed from a combustion resistant material, for example, a resilient wire mesh, when used in a fire prone environment. Upper plate 58 and lower plate 60 may be substantially rigid and formed of any known material including, for example, steel. Each of first, second, and third mounting supports 50, 52, 54 may also include a mounting bracket 62 connecting upper plate 58 to lower surface 44 of support structure 20. Each of first, second, and third mounting supports 50, 52, 54 may also be connected to base surface 26. Upper plate 58 and lower plate 60 may be may connected to support structure 20 and base surface 26, respectively, for example, by one or more fasteners (not shown).

In addition to third mounting support 54, second mounting assembly 30 may include one or more shock absorbers for regulating the amount of twisting of support structure 20 about third mounting support 54. Each of the one or more shock absorbers of second mounting assembly 30 may be any known type of shock absorber. The one or more shock absorbers of the second mounting assembly 30 may include a first hydraulic shock absorber 64 and a second hydraulic shock absorber 66. Third mounting support 54 may be positioned between first hydraulic shock absorber 64 and second hydraulic absorber 66, such that first hydraulic shock absorber 64 may be mounted near first side 36 of support structure 20 and second hydraulic shock absorber 66 may be mounted near second side 38 of support structure 20. As an alternative to implementing first and second shock absorbers 64, 66, it is contemplated that a single shock absorber (e.g., first hydraulic shock absorber 64) may be mounted near third mounting support 54. For example, it may be particularly beneficial to use a single shock absorber in an arrangement where the torque on support structure 20 tends to be in one direction.

Each of first and second hydraulic shock absorbers 64, 66 may include a cylinder 68 having a first internal fluid reservoir (not shown) separated from a second internal fluid reservoir (not shown) by a piston (not shown). The piston may be connected to a piston rod 70. First and second shock absorbers 64, 66 may be connected to lower surface 44 of support structure 20 via a first mount 72 and to base surface 26 by a second mount 74. For example, cylinder 68 may connect to first mount 72 and piston rod 70 may connect to second mount 74. The piston may be guided by movement of piston rod 70 and may be permitted to travel through cylinder 68 by pressing fluid from the first fluid reservoir into the second fluid reservoir through a valve (not shown) including, for example, one or more orifices in the piston. The properties of the fluid (e.g., viscosity) and the size and orientation of the orifices may determine the stiffness of each hydraulic shock absorber 64, 66. It is contemplated that each hydraulic shock absorber 64, 66 may be tuned to regulate stiffness. In other words, each hydraulic shock absorber 64, 66 may be tailored to be less resistant to torque transferred to support structure 20 than third mounting support 54 at torque levels below a threshold value, but each hydraulic shock absorber 64, 66 may be more resistant to torque transferred to support structure 20 than third mounting support 54 at torque levels above a threshold value.

### INDUSTRIAL APPLICABILITY

The disclosed mounting system may be applicable to supporting any power system including a drive mechanism and a driven mechanism on a support structure. The mounting system may include a three point support arrangement including at least one shock absorber for regulating twisting of the support structure. Further, the mounting system may permit twisting of the support structure during low torque levels, and may limit twisting of the support structure during high torque levels. The operation of the mounting system will be described below.

First and second mounting assemblies 28, 30 may permit twisting of support structure 20 relative to base surface 26 in order to protect power system 10 from damage including, for example, misalignment of electric motor 16 and compressor 18. Under normal operating conditions (e.g., low level torque generated by electric motor 16), first and second mounting assemblies 28, 30 may permit twisting of support structure 20 proximate electric motor 16. Under abnormal operating conditions (e.g., high level torque generated by electric motor 16), first and second mounting assemblies 28, 30 may limit twisting of support structure 20 via first and second hydraulic shock absorbers 64, 66. An abnormal operating condition may include, for example, a short circuit in electric motor 16 that causes a large reactionary torque. An abnormal condition may also be generated external to power source 10, for example, by a seismic event.

In order to regulate the amount that support structure 20 is permitted to twist, second mounting assembly 30 may implement first and second hydraulic shock absorbers 64, 66. The stiffness of each hydraulic shock absorber 64, 66 may be tailored to regulate movement of piston rod 70 within cylinder 68. For example, the orifices within each of first and second hydraulic shock absorber 64, 66 may be sized so that during normal operation they permit each piston rod 70 to freely telescope within cylinder 68 and thereby minimally obstruct support structure 20 from twisting about third mounting support 54. In other words, at low torque levels, the orifices may permit fluid to flow from the first reservoir of cylinder 68 into the second reservoir of cylinder 68 at a flow rate sufficient to permit twisting of support structure 20. However, during abnormal operation at high torque levels, the orifices may be too small to permit piston rod 70 to freely telescope within cylinder 68 and thereby effectively limiting support structure 20 from twisting about third mounting support 54. In other words, during high torque levels, the orifices within first and second shock absorbers 64, 66 may not be adequately sized to permit fluid to pass from the first reservoir of cylinder 68 to the second reservoir of cylinder 68 at a rate sufficient to permit twisting.

It is contemplated that different types of power systems 10 including different types of drive mechanisms 12 and driven mechanisms 14 may each require first and second hydraulic shock absorbers 64, 66 to be specifically selected or tuned in accordance with the particular characteristics of the power system. For example, an operator may tune each hydraulic shock absorber 64, 66 to define a threshold torque level to regulate twisting of support structure 20. In other words, first and second hydraulic shock absorbers 64, 66 may be selected or tuned to permit twisting of support structure 20 proximate electric motor 16 when torque on support structure 20 is below a threshold value, and may limit twisting of support structure 20 proximate electric motor 16 when torque on support structure 20 is above the threshold value.

Power system 10 may be protected from damage by implementing the three point mounting arrangement of first and second mounting assemblies 28, 30 incorporating first and second hydraulic shock absorbers 64, 66 to regulate twisting of support structure 20 under various operating conditions. Therefore, first and second mounting assemblies 28, 30 may protect power system 10 under both low torque levels (e.g., normal operating conditions) and under high torque levels (e.g., abnormal operating conditions). For example, first and second mounting assemblies 28, 30 may protect power system 10 under low torque levels by absorbing vibrations, and may protect power system 10 under high torque levels by limiting the amount of twisting of support structure 20 that may distort or break power system components.

It will be apparent to those skilled in the art that various modifications and variations can be made to the disclosed mounting system without departing from the scope of the disclosure. Other embodiments of the present disclosure will be apparent to those skilled in the art from consideration of the specification and practice of the method and apparatus disclosed herein. It is intended that the specification and examples be considered as exemplary only, with a true scope of the disclosure being indicated by the following claims and their equivalents.

What is claimed is:

1. A mounting system for supporting a power system including a drive mechanism powering a driven mechanism along a longitudinal axis, comprising:
a support structure including a first end spaced from a second end of the support structure;
a first mounting assembly attached near the first end of the support structure, the first mounting assembly including a first mounting support and a second mounting support for supporting the support structure, each of the first mounting support and the second mounting support attached to the support structure offset to a side of the longitudinal axis; and
a second mounting assembly attached near the second end of the support structure, the second mounting assembly including a third mounting support attached to the support structure below the longitudinal axis for supporting the support structure, the second mounting assembly also including at least one shock absorber mounted near the third mounting support, the at least one shock absorber attached to the support structure offset to a side of the longitudinal axis.

2. The system of claim 1, wherein the first mounting support, the second mounting support, and the third mounting support permit relative movement of the support structure.

3. The system of claim 1, wherein the first mounting support, the second mounting support, and the third mounting support are each either an anti-vibration mount or a gimbal.

4. The system of claim 3, wherein at least one of the first mounting support, the second mounting support, and the third mounting support is an anti-vibration mount including a layer of resilient wire mesh.

5. The system of claim 1, wherein the at least one shock absorber includes two shock absorbers.

6. The system of claim 5, wherein the two shock absorbers are each hydraulic shock absorbers.

7. The system of claim 5, wherein the third mounting support is positioned between the two shock absorbers.

8. The system of claim 1, wherein the driven mechanism is mounted near the first end of the support structure and the drive mechanism is mounted near the second end of the support structure.

9. The system of claim 8, wherein the first mounting assembly is mounted beneath the driven mechanism and the second mounting assembly is mounted beneath the drive mechanism.

10. The system of claim 9, wherein the drive mechanism is an electric motor and the driven mechanism is a compressor.

11. The system of claim 1, wherein the at least one shock absorber is less resistant to torque transferred to the support structure than the third mounting support at torque levels below a threshold value, and the at least one shock absorber is more resistant to torque transferred to the support structure than the third mounting support at torque levels above the threshold value.

12. A method of supporting a drive mechanism and a driven mechanism on a support structure, comprising:
supporting the driven mechanism near a first end of the support structure and supporting the drive mechanism near a second end of the support structure;
permitting the support structure to twist more proximate the drive mechanism than the driven mechanism in response to torque generated on the support structure below a threshold value; and
limiting twisting of the support structure near the drive mechanism when the torque generated on the support structure is above the threshold value.

13. The method of claim 12, wherein supporting the driven mechanism near the first end includes supporting the driven mechanism above a first mounting assembly including side-by-side first and second mounting supports.

14. The method of claim 12, wherein supporting the drive mechanism near the second end includes supporting the drive mechanism above a second mounting assembly including a third mounting support and at least one shock absorber.

15. The method of claim 14, wherein permitting twisting of the support structure includes permitting twisting about the third mounting support.

16. The method of claim 14, wherein limiting twisting of the support structure near the drive mechanism includes limiting twisting of the support structure at least in part with the at least one shock absorber.

17. An electric motor drive compressor package, comprising:
a compressor mounted on a support structure near a first end of the support structure;
an electric motor mounted on the support structure near a second end of the support structure, the compressor and the electric motor including a longitudinal axis;
a compressor mounting assembly attached to a lower surface of the support structure beneath the compressor, the compressor mounting assembly including a first mounting support and a second mounting support, each of the first mounting support and the second mounting support attached to the support structure offset to a side of the longitudinal axis; and
an electric motor mounting assembly attached to the lower surface of the support structure beneath the electric motor, the electric motor mounting assembly including a third mounting support attached to the support structure below the longitudinal axis, the second mounting assembly also including a first shock absorber and a second shock absorber attached to the lower surface of the support structure, the third mounting support positioned between the first shock absorber and the second shock absorber.

18. The electric drive motor compressor package of claim 17, wherein each of the first mounting supporting, the second mounting support, and the third mounting support is either an anti-vibration mount or a gimbal.

19. The electric drive motor compressor package of claim 17, wherein the first shock absorber and the second shock absorber are hydraulic shock absorbers.

20. The electric drive motor compressor package of claim 17, wherein the first shock absorber and the second shock absorber are less resistant to torque transferred to the support structure than the third mounting support at torque levels below a threshold value, and the first shock absorber and the second shock absorber are more resistant to torque transferred to the support structure than the third mounting support at torque levels above the threshold value.
